(19) United States
(12) Patent Application Publication
(10) Pub. No.: US 2019/0342666 A1
(43) Pub. Date: Nov. 7, 2019

(54) DIAPHRAGM FOR A RECEIVER

(71) Applicant: Knowles Electronics, LLC, ltasca, IL (US)

(72) Inventors: Paul Dayton, Wayne, IL (US); Yahui Zhang, Schaumburg, IL (US); Alexander Grossman, Geneva, IL (US); Shehab Albahri, Hanover Park, IL (US); Matthew Manley, Crystal Lake, IL (US)

(21) Appl. No.: 16/467,640

(22) PCT Filed: Dec. 8, 2017
(86) PCT No.: PCT/US2017/065263

§ 371 Date: Jun. 7, 2019

Related U.S. Application Data
(60) Provisional application No. 62/431,579, filed on Dec. 8, 2016.

(51) Int. Cl. H04R 7/20; H04R 9/06

(52) U.S. Cl. CPC H04R 7/20; H04R 2207/021; H04R 9/06

(57) ABSTRACT

An acoustic receiver diaphragm includes a frame with an opening extending therethrough. A paddle is disposed in the opening, and a gap extends between portions of the paddle and the frame. A hinge connects the paddle to the frame. The hinge has a coined portion, and the paddle is movable relative to the frame upon flexing the coined portion of the hinge. A portion of the frame, the paddle, and the hinge form an unassembled, single-piece substantially planar member.

### TECHNICAL FIELD

This disclosure relates to acoustic devices and, more specifically, to acoustic devices having movable diaphragms.

### BACKGROUND

Various types of acoustic devices have been used over the years. One example of an acoustic device is a receiver. In aspects, a receiver includes a coil, magnets, a diaphragm (including a paddle), and a yoke (among other components) and these components are disposed within a housing. An electric current (representing sounds to be produced) moves through the coil, and changes the magnetic fields in the receiver, thereby displacing the armature. Movement of the armature, in turn, displaces a drive rod or pin connected to the diaphragm, causing the diaphragm to vibrate and produce sound.

One characteristic of the receiver that determines its effectiveness and efficiency in producing sound is sensitivity. Generally speaking, “sensitivity” relates to the amount of force required to move the diaphragm. Typically, it is desirable to have a more sensitive receiver than a less sensitive receiver. In aspects, the sensitivity itself may depend on the stiffness of the diaphragm.

Various approaches for increasing the sensitivity of receivers have been attempted, but have shortcomings.

### BRIEF DESCRIPTION OF THE DRAWINGS

For a more complete understanding of the disclosure, reference should be made to the following detailed description and accompanying drawings wherein:

FIG. 1 is an exploded view of a receiver;

FIG. 2 is a cutaway view of a portion of the receiver of FIG. 1;

FIG. 3 is a perspective view of a diaphragm that is s-shaped and has a cantilever hinge;

FIG. 4 is a perspective view of a diaphragm that is s-shaped and has a torsional hinge;

FIG. 5 is a perspective view of a diaphragm that extends generally along a single plane and is not s-shaped;

FIGS. 6A and 6B are side views of the coined area of a hinge;

FIGS. 7A and 7B are views of another example of a hinge where portions of the hinge, frame, and/or paddle are coined;

FIG. 8 is a perspective view of a diaphragm that is c-shaped and has a cantilever hinge.

Those of ordinary skill in the art will appreciate that elements in the figures are illustrated for simplicity and clarity. It will be appreciated further that certain actions and/or steps may be described or depicted in a particular order of occurrence while those having ordinary skill in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

The approaches described herein provide a receiver diaphragm with a coined hinge area. Advantageously, coining an area of the hinge results in greater sensitivity for the receiver. As the stiffness is adjusted by coining, the sensitivity and/or resonance frequency are adjusted. Generally speaking, the lower the stiffness of the diaphragm, the greater the sensitivity and the lower the resonance frequency.

In some of these examples, an acoustic receiver diaphragm includes a frame with an opening extending through the frame. A paddle is disposed in the opening, and a gap extends between portions of the paddle and the frame. A hinge connects the paddle to the frame. The hinge has a coined portion, and the paddle is movable relative to the frame upon flexing the coined portion of the hinge. In one embodiment, a portion of the diaphragm including the frame, the paddle, and the hinge form an unassembled, single-piece substantially planar member.

In aspects, a portion of the diaphragm is constructed of a metal and the coined portion of the hinge is plastically deformed in a cold working process. For example, the diaphragm can be constructed of stainless steel, aluminum, and nickel among other metals and alloys thereof. In other embodiments, a portion of the diaphragm is constructed of a non-metal material that may be coined. Such non-metal materials such as plastics, and carbon fiber reinforced polymers can also be used. In one embodiment, the diaphragm is fabricated from a single-piece of material in a stamping, milling or routing operation after a portion of the material from which the hinge is formed is coined. In other embodiments, coining occurs after the milling, routing or stamping operation.

In other aspects, the coined portion of the hinge has a first thickness and portions of the frame or the paddle adjacent the hinge have a second thickness, wherein the first thickness is less than the second thickness. In some embodiments, coining reduces the thickness of at least a portion of the hinge but not the thickness of other portions of the diaphragm.

In yet other aspects, the frame has one or more flanges extending from portions of the frame. In one embodiment, the frame including the one or more flanges has s-shaped profile when viewed from one perspective. In one specific example, the frame includes flanges at opposite ends of the substantially planar member formed by the portion of the frame, the paddle, and the hinge, and the diaphragm has a generally s-shaped configuration. The flanges may be formed integrally with the diaphragm as an assembled or an unassembled unitary member. In other examples, the frame includes flanges at same ends of a substantially planar member formed by the portion of the frame, the paddle, and the hinge, and the diaphragm has a generally c-shaped configuration.

The hinges may be arranged in different ways and relative positions in the gap between the paddle and the frame of the diaphragm. In one example, the hinge comprises first and second torsional members interconnecting the paddle and the frame wherein the first and second torsional members are disposed on opposite sides of the paddle along a common pivot axis. In another example, the hinge includes one or more members interconnecting the paddle and the frame along a common side of the paddle wherein the one or more members form corresponding cantilever hinges.

In still other aspects, the one or more coined portions of the diaphragm has a material property that differs from a material property of uncoined portions of the diaphragm (either the uncoined portion of the hinge or uncoined portions of the diaphragm). For instance, the material strength may be greater in the coined portions of the diaphragm compared to uncoined portions of the diaphragm. In other examples, the ductility in the coined portion may be different than the ductility in the uncoined portion. Coining may also affect other properties of the diaphragm.

In other examples, the diaphragm is tuned to a predetermined resonance frequency which can be described as:

$$f = \frac{1}{2 π} \sqrt{\frac{k}{m}}$$

where f is the resonance frequency, m is the mass, and k is the stiffness. By changing the stiffness, the resonance frequency can be changed.

Advantageously, coining reduces this resonance frequency compared the resonance frequency that would be result from an uncoined diaphragm having the same dimensions.

In other aspects, the acoustic receiver includes a coil, at least one magnet, an armature extending through the coil and adjacent to the at least one magnet, and a diaphragm. The diaphragm includes a frame with an opening extending through the frame; a paddle located in the opening; a gap between portions of the paddle and the frame; and a coined hinge connecting the paddle to the frame. A portion of the frame, the paddle, and the coined hinge form an unassembled, single-piece substantially planar member. A linkage connects the armature and the paddle.

In other examples, an acoustic receiver diaphragm includes a paddle; a peripheral frame disposed about the paddle; a hinge flexibly interconnecting the paddle and the peripheral frame; and a gap between portions of the paddle and the peripheral frame not interconnected by the hinge. The paddle is movable relative to the peripheral frame upon flexing the hinge. A portion of the frame, the paddle, and the hinge form an unassembled, single-piece of substantially planar metal material. A thickness of a first portion of the hinge is less than a thickness of a portion of the peripheral frame and a portion of the paddle adjacent the hinge.

In aspects, the portion of the hinge having less thickness is coined. In examples, a second portion of the hinge and portions of the peripheral frame and paddle adjacent the hinge portion have a common thickness. A cross-sectional area of the first portion of the hinge is less than a cross-sectional area of the second portion of the hinge. In examples, the frame includes flanges at opposite ends of the substantially planar member formed by the portion of the frame, the paddle, and the hinge. In examples, the diaphragm has a generally s-shaped configuration.

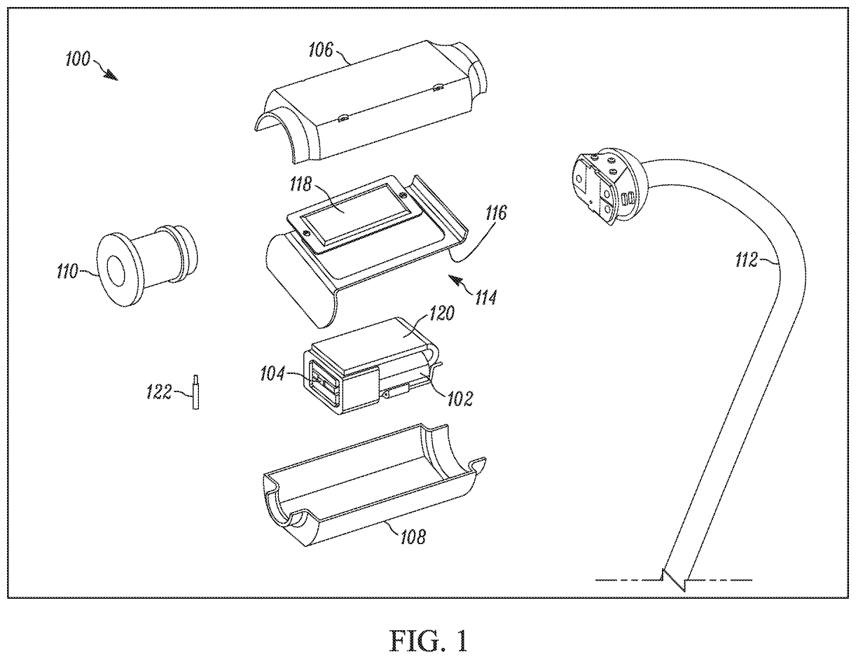

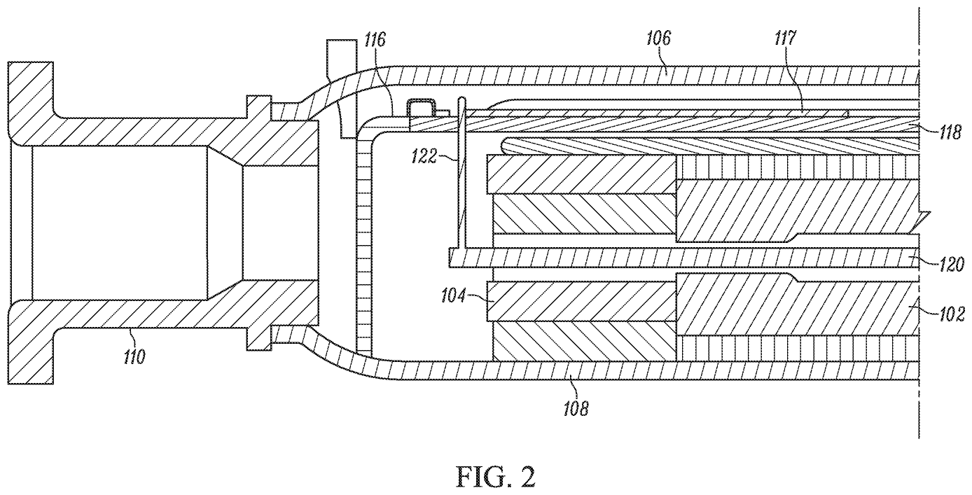

Referring now to FIGS. 1-5, one example of a receiver 100 is described. The receiver 100 includes a coil 102, magnets 104, an upper housing 106, a lower housing 108, a sound tube 110, an electrical cable 112, a diaphragm 114 (including a frame 116 and a paddle 118), an armature 120, and a drive rod (or pin) 122. In FIG. 2, a flexible membrane 117 extends over the top of the diaphragm and covers the gap between the paddle and the frame. The flexible membrane (annulus) 117 is constructed of, in one example, a plastic film such as urethane, Mylar or silicone. Other examples are possible. The upper housing 106 and lower housing 108 couple together forming a chamber enclosing the coil 102, magnets 104, diaphragm 114, armature 120, and drive rod 122.

An electric current (representing sounds or acoustic energy to be rendered to a user) is input into the receiver 100 via the cable 112 and then applied to the coil 102. Current through the coil 102 creates a changing magnetic field, which displaces the armature 120, which (in turn) displaces a drive rod or pin 122, causing the paddle 118 of the diaphragm 114 to vibrate and create the desired sound. Sound exits through a port in the housing (formed by upper housing 106 and lower housing 108) and then through the sound tube 110 to a listener.

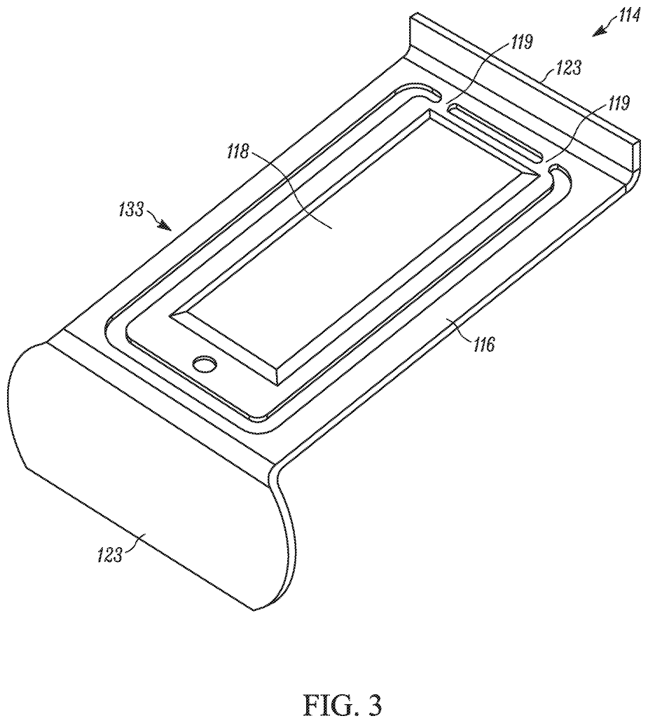

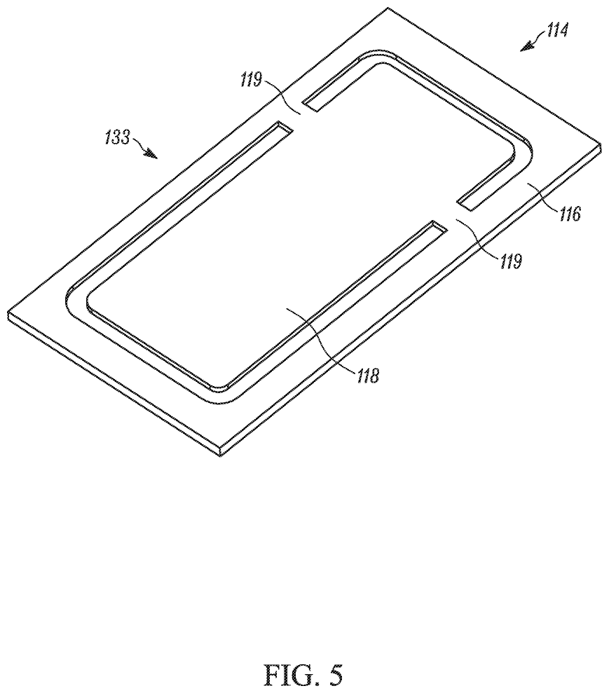

In FIGS. 3 and 5, hinges 119 connect the paddle 118 and the frame 116 across a gap. As explained in greater detail below, the hinges 119 can be positioned at various places in the gap between the frame 116 and the paddle 118.

Furthermore, the hinges 119 are coined. The entire hinge 119 may be coined or only parts of the hinge may be coined. Whether coined entirely or in part, the coined portion of a hinge 119 is of a reduced thickness relative to other portions of the diaphragm (e.g., the frame 116 and paddle 118). The dimensions of the coined hinge or coined portion of the hinge depend on many factors including the desired stiffness of the diaphragm, properties of the material, and the dimensions of the hinge and paddle, among other factors. In one example, the coined portions of the hinge are approximately 50% the thickness of the uncoined portions. In aspects, there are no absolute dimensions for the coined area. The above-mentioned percentage can be adjusted based on application.

In aspects, the coined portion of the hinge has a first thickness, and portions of the frame or the paddle adjacent the hinge have a second thickness, and the first thickness is less than the second thickness. In other words, coining reduces the thickness of the hinge. Depending on when coining occurs in the manufacturing process, the dimensions of the hinge can either remain the same or change as a result of coining.

During construction of the diaphragm, the coining may be performed on portions of a blank sheet of material, thereby reducing the thicknesses of these portions. After coining, the diaphragm 114 may be stamped, milled or routed from the blank sheet. Thus, the diaphragm 114 is formed of a single, unassembled unitary member.

It will be appreciated that the diaphragm 114 has a first dimension (length) that is greater than a second dimension (width) or a third dimension (thickness). In FIG. 3, the hinges 119 are cantilever hinges and are provided along a common end of the paddle rather than on opposite sides thereof, along a common axis. In particular, the cantilever hinges extend parallel and outwardly from a common end of the paddle.

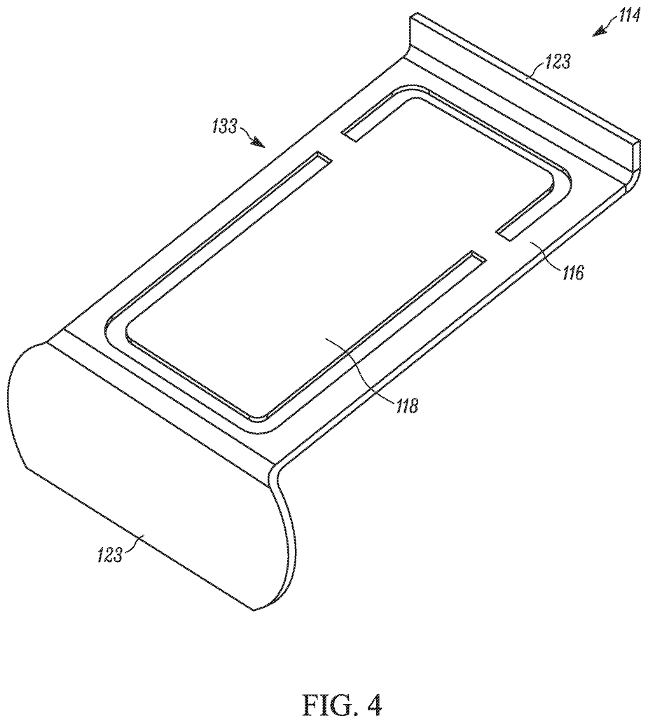

In FIG. 4, the hinges are torsional hinges and extend outward from opposite sides of the paddle along a common axis. As the paddle 180 moves, a torque is applied at the hinges 119. This action contrasts with a bending motion of cantilever hinges in FIG. 3.

In some embodiments, the diaphragm 114 and/or portions of the diaphragm 114 form a single, unassembled unitary member. In FIG. 5, for example, the entire diaphragm 114 is a single-piece substantially planar member wherein the frame 116, the paddle 118, and the hinges 119 form the unassembled, single-piece substantially planar member. In FIG. 5, the diaphragm is devoid of flanges extending from the planar member.

In FIGS. 3 and. 4, portions of the diaphragm 114 are formed or extend in multiple planes to form an s-shaped member. More specifically, flanges 123 at opposite ends of a substantially planar member 133 are formed by portions of the frame. In this case, the diaphragm 114 has a generally s-shaped configuration. As disposed within the receiver 100, the top one of the flanges 123 is coupled to the upper housing and the bottom one of the flanges 123 is coupled to the bottom housing to partially define front and back volumes of the housing on opposite sides of the diaphragm. In other embodiments, the diaphragm includes only a single flange extending from a side or end of the frame. In some embodiments, generally, the one or more flanges extending from the diaphragm define a boundary between portions of the front and back volumes of the housing.

The diaphragm 114 can be constructed from a wide variety of materials. For example, the diaphragm can be constructed of stainless steel, aluminum, and nickel. Other materials may also be used. In aspects, the diaphragm 114 is constructed of a metal and the coined portion of the hinge is plastically deformed in a cold working process.

As mentioned, the hinges 119 have a coined portion. In some aspects, the coined portion has a first cross-sectional area before coining, and a second cross-sectional area after coining. The second cross-sectional area is less than the first cross-sectional area. During manufacturing, the area that is designated as the hinge may be stamped. The stamping extends the cross-sectional area outward. The excess area can be cut or otherwise shaved or trimmed off. Thus, the cross-sectional area of the coined portion of the hinge is reduced from what the cross-sectional area of the hinge was before the coining process was performed.

In other examples, the first and second cross-sectional areas remain the same before and after coining. Consequently, the excess area is not trimmed.

In other examples, the hinge is configured to tune the resonance frequency of the diaphragm. In some implementations, it is desirable to lower the resonance frequency of the diaphragm to improve performance of the receiver. Consequently, the characteristics of the hinge can be selected to tune the resonance frequency. In particular, the thickness and stiffness of the hinge can be adjusted as needed to provide a specific resonance frequency.

Structurally, the coined portion of the hinge has increased hardness or strength (compared to portions of the diaphragm that were not coined). In this coined structure, the crystal structure of the material used to construct the diaphragm 114 does not slip (or slip less), and imperfections are locked in place. In other aspects, the tensile and yield strengths of the material are increased by the coining of portions of the hinge 119.

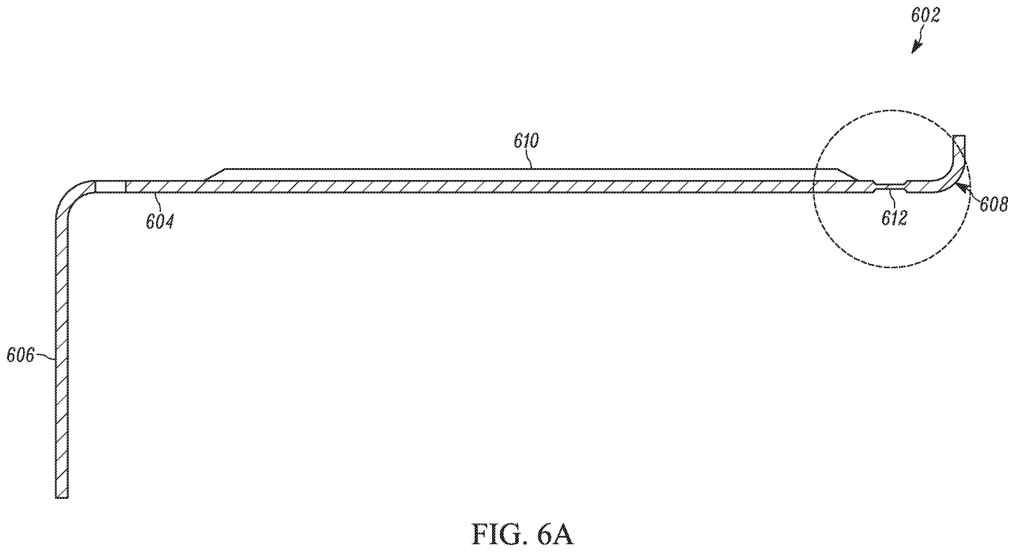

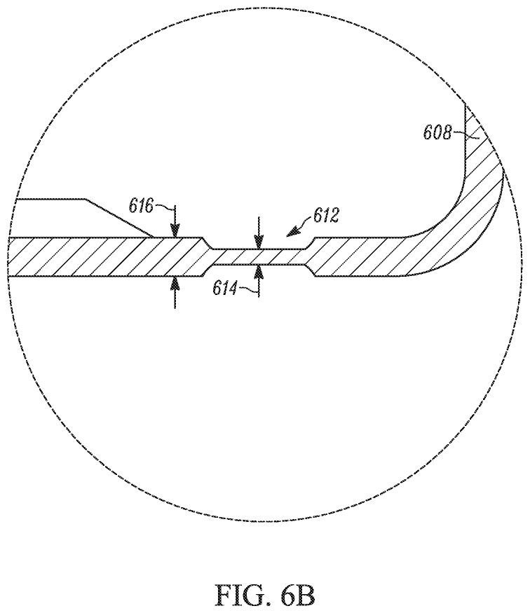

Referring now to FIGS. 6A and 6B, one example of a diaphragm 602 (in this case, an s-shaped diaphragm) including a frame 604, a first flange 606 (extending from the frame 604), a second flange 608 (extending from the frame 604), a membrane 610, and a hinge 612. In aspects, the diaphragm 602 may resemble the diaphragm shown in FIG. 3 and include a paddle (not shown in FIG. 6A or FIG. 6B). The hinge 612 is coined with a thickness 614 that is less than the thickness 616 of the frame 604.

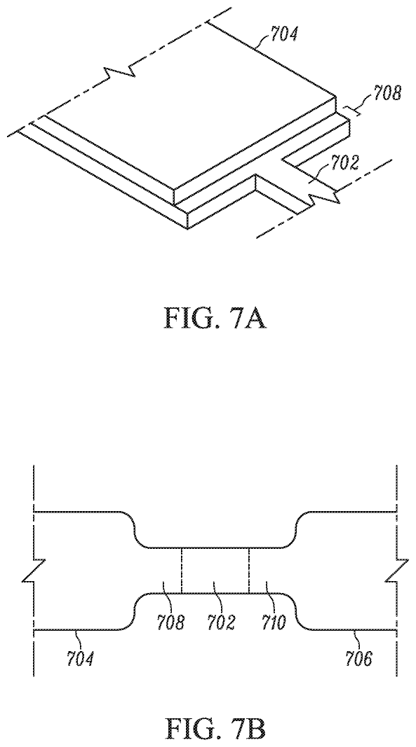

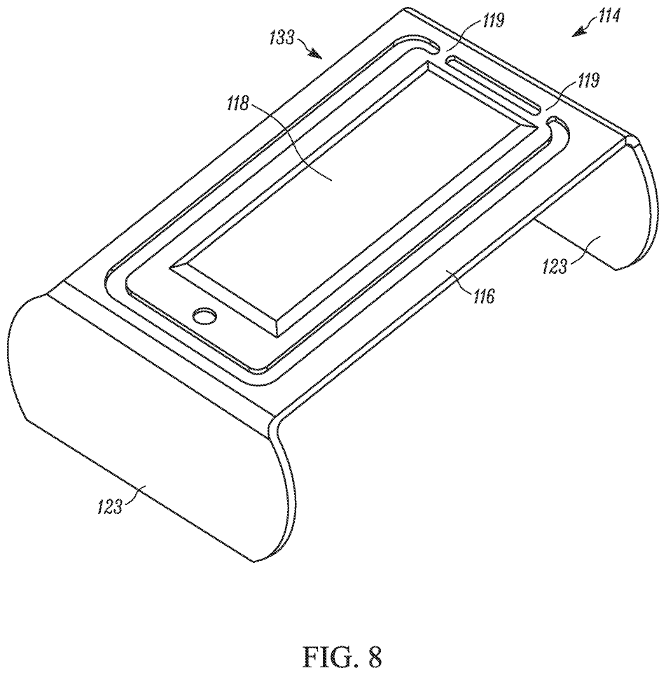

Referring now to FIGS. 7A and 7B, one example of coining portions of a hinge, frame, and/or paddle is described. In this example, a hinge 702 connects a paddle 704 to a frame 706. It can be seen that the entire hinge 702 is coined (has a reduced thickness compared to other portions of the paddle and frame). It can also be seen that a portion 708 of the paddle and a portion 710 of the frame are also coined. In other examples, only one of the paddle or frame is coined.

Referring now to FIG. 8, another example of a diaphragm is shown. This example is similar to the example of FIG. 3 and like parts are numbered with the same part numbers. However, the example of FIG. 8 differs from the example of FIG. 3 in that flanges 123 form (with the substantially planar member 133) a c-shaped member, instead of an s-shaped member. The example of FIG. 8 shows a cantilever hinge. However, it will be appreciated that the example of FIG. 8 may also be used with a torsional hinge structure.

Preferred embodiments of this disclosure are described herein, including the best mode known to the inventor(s). It should be understood that the illustrated embodiments are exemplary only, and should not be taken as limiting the scope of the appended claims.

1. An acoustic receiver diaphragm comprising:
a frame with an opening extending therethrough;
a paddle disposed in the opening;
a gap extending between portions of the paddle and the frame;
a hinge that connects the paddle to the frame, the hinge having a coined portion, the paddle being movable relative to the frame upon flexing the coined portion of the hinge;
wherein a portion of the frame, the paddle, and the hinge form an unassembled, single-piece substantially planar member.

2. The diaphragm of claim 1, wherein diaphragm is a metal and the coined portion of the hinge is plastically deformed in a cold working process.

3. The diaphragm of claim 1, wherein the coined portion has a first cross-sectional area before coining and a second cross-sectional area after coining, the second cross-sectional area being less than the first cross-sectional area.

4. The diaphragm of claim 1, wherein the coined portion of the hinge has a first thickness, and portions of the frame or the paddle adjacent the hinge have a second thickness, and wherein the first thickness is less than the second thickness.

5. The diaphragm of claim 1, wherein the coined portion of the hinge has a first thickness, wherein the hinge has an uncoined portion of a second thickness, and wherein the first thickness is less than the second thickness.

6. The diaphragm of claim 1, wherein the frame includes flanges at opposite ends of the substantially planar member formed by the portion of the frame, the paddle, and the hinge, and wherein the diaphragm has a generally s-shaped configuration.

7. The diaphragm of claim 1, wherein the hinge comprises first and second torsional members interconnecting the paddle and the frame, the first and second torsional members disposed on opposite sides of the paddle along a common pivot axis.

8. The diaphragm of claim 1, wherein the hinge includes at least one member interconnecting the paddle and the frame along a single side of the paddle.

9. The diaphragm of claim 1, wherein the diaphragm is constructed from a material selected from the group consisting of: stainless steel, aluminum, and nickel, and a carbon fiber reinforced polymer.

10. The diaphragm of claim 1, wherein the hinge has a first material property, and the paddle and the frame a second material property, wherein the first material property is different than the second material property.

11. The diaphragm of claim 10, wherein the first material property and the second material property are a material strength or ductility.

12. The diaphragm of claim 1, wherein the hinge is configured to tune the diaphragm to a predetermined resonance frequency.

13. An acoustic receiver comprising;
a coil;
at least one magnet;
an armature extending through the coil and adjacent to the at least one magnet;
a diaphragm including:
a frame with an opening extending therethrough;
a paddle located in the opening;
a gap between portions of the paddle and the frame;
a coined hinge connecting the paddle to the frame,
wherein a portion of the frame, the paddle, and the coined hinge form an unassembled, single-piece substantially planar member; and
a linkage connecting the armature and the paddle.

14. The receiver of claim 13, wherein the coined portion of the hinge has a first thickness, and the frame or the paddle has a second thickness, and wherein the first thickness is less than the second thickness.

15. The receiver of claim 13, wherein the coined portion has a first thickness, wherein the hinge has an uncoined portion of a second thickness, and wherein the first thickness is less than the second thickness.

16. The receiver of claim 13 further comprising a housing disposed about the coil, the magnet, the armature, and the diaphragm,
the housing having a front volume on one side of the diaphragm and a back volume on an opposite side of the diaphragm,
the frame including a flange extending at an angle relative to the substantially planar member formed by the portion of the frame, the paddle, and the hinge, and wherein the flange defines a boundary between a portion of the front volume and a portion of the back volume.

17. An acoustic receiver diaphragm comprising:
a paddle;
a peripheral frame disposed about the paddle;
a hinge flexibly interconnecting the paddle and the peripheral frame;
a gap between portions of the paddle and the peripheral frame not interconnected by the hinge, wherein the paddle is movable relative to the peripheral frame upon flexing the hinge;
a portion of the frame, the paddle, and the hinge form an unassembled, single-piece of substantially planar metal material,
a thickness of a first portion of the hinge is less than a thickness of a portion of the peripheral frame and a portion of the paddle adjacent the hinge.

18. The diaphragm of claim 18, wherein the portion of the hinge having less thickness is coined.

19. The diaphragm of claim 18, a second portion of the hinge and portions of the peripheral frame and paddle adjacent the hinge portion have a common thickness, a cross-sectional area of the first portion of the hinge is less than a cross-sectional area of the second portion of the hinge.

20. The diaphragm of claim 19, the frame includes flanges at opposite ends of the substantially planar member formed by the portion of the frame, the paddle, and the hinge, wherein the diaphragm has a generally s-shaped configuration.
